(19) United States
(12) Patent Application Publication
(10) Pub. No.: US 2001/0027473 A1
(43) Pub. Date: Oct. 4, 2001

(54) Coordination service system

(76) Inventor: Yasuhiro Kawakita, Osaka (JP)

Correspondence Address: VENABLE, Post Office Box 34385, Washington, DC, 20043-9998, US

(21) Appl. No.: 09/725,318

(22) Filed: Nov. 29, 2000

(30) Foreign Application Priority Data
Mar. 30, 2000 (JP) JP2000-97855

(51) Int. Cl. G06F 15/16

(52) U.S. Cl. 709/204; 709/218

(57) ABSTRACT

The system is for searching job components required for a predetermined job, effectively and in a short time, and for online purchasing the job components required reliably with a user terminal connected to a network. A service system comprises a plurality of job method provider terminals 101 for providing information Web pages for a predetermined job method, and a plurality of job component provider terminals 100 for providing job components necessary to perform the predetermined job method, for delivering the job components and for settling an account of a payment for the job components. Both of them are connected to a user terminal 103 via a computer network 104. In the system a coordination terminal 102 for ordering the job components necessary for the predetermined job method, on the information Web pages of the predetermined job method, browsed by the user, directly from the job component provider terminal 100 is further connected.

### BACKGROUND OF THE INVENTION

The present invention relates to a coordination service system, more specifically, relates to a coordination service system for searching various services from a user terminal connected to a network, typically an Internet, and purchasing goods online.

### PRIOR ART

In recent years, a system that a service provider provides a whole lot of goods, information (such as data or contents), services and so forth by way of a computer network, such as an Internet, and a user browses and purchases those goods or the like, is constructed. In case where a user intends to purchase those goods or the like by using that system, the user may order goods or the like from a provider selling information, such as a recipe for cooking, or foodstuff itself for cooking, for example, as commodities, by way of a browsing screen of user terminal through a network.

Such a system is reported in a morning edition of Nikkei Sangyo Shimbun (Nikkei Industry Newspaper) dated Dec. 24, 1999, for example. As described in this article, there are cooking recipe providing sites for introducing preparations and ingredients for a variety of cooking on a network, and a user can browse the providing sites and obtains information free of charge. Moreover, pay contents, such as in the form of CD-ROM, for example, are also sold.

As reported in a morning edition of Nihon Keizai Shimbun (Nikkei Newspaper) dated Jan. 12, 2000, for example, there are sites for selling foodstuffs on a network. User can order for foodstuffs and request for delivery service by sending an order form in designated format required for the accessed site.

However, on a computer network, as a site for providing a job method and a site for providing a job component such as a material or a tool each are exist independently, a user must determined a job method by browsing a job method site, thereafter investigate materials required for the job by himself or herself, browse a provider site for providing the materials, and then order the material required.

For example, in case where a user intends to cook using predetermined foodstuffs, the user must browse a cooking recipe site and determine a dish, thereafter investigate foodstuffs required for a cooking by himself or herself, browse a foodstuff provider site for providing the foodstuffs themselves, and then order the required foodstuffs, because the site for providing cooking recipes and the site for providing foodstuffs exist independently each other.

As described above, the browsing period of the user becomes long because every site of them must be browsed. Especially, for a general consumer who accesses from home or the like by way of a public telephone line, communication cost is much expensive. Moreover, it is difficult that user finds out a site that handles the entire foodstuff required for cooking in a short time and efficiently after determining a dish.

In contrast, there exist a service that manages a provision of cooking recipes and a provision of foodstuffs themselves in a same site. In this case, a service provider must manages both databases, i.e., a database of cooking recipes and a database of foodstuffs themselves. What is more, as data of cooking recipes and foodstuffs themselves provided on a same site are limited with the service provider, data amount of such data is very small in comparison with data amount of all cooking recipes and foodstuffs themselves provided on a network.

### SUMMARY OF THE INVENTION

The object of the invention is, therefore, to provide a novel and improved coordination service system capable of retrieving job components required for a predetermined job efficiently and in a short time, and online purchasing the required job components certainly, by way of a user terminal connected to a network, typically an Internet.

To solve the above object, according to this invention, a coordination service system which includes a service system comprising a plurality of job method provider terminals for providing information Web pages for a predetermined job method, and a plurality of job component provider terminals for providing job components necessary to perform the predetermined job method, for delivering the job components and for settling an account of a payment for the job components, the job method provider terminals and the job component provider terminals both being connected to a user terminal via a computer network, characterized by further comprising: a coordination terminal for ordering the job components necessary for the predetermined job method, on the information Web pages of the predetermined job method, browsed by the user, directly from the job component provider terminal, is provided.

In this invention, a terminal (coordination terminal) for coordinating a plurality of provider sites to provide predetermined job methods and a plurality of provider sites to provide job components such as materials or tools is located on a network. When the predetermined job method provider site responsive to a request of a user is displayed, a button for indicating an intention of ordering job components (for example, foodstuffs), such as materials or tools, required for the predetermined job may be additionally displayed on a part of a screen, for example. If so a user can automatically extract foodstuffs required for the selected dish from a foodstuff provider terminal and order them, by means of selecting and determining a dish from cooking recipes and pressing the foodstuff ordering button, for example. As this coordination terminal does not required for holding a database of cooking recipes and a database of foodstuffs, for example, the coordination terminal does not required for a function of searching cooking recipes and foodstuffs. According to that system, as there is no necessity that a user browses foodstuff provider sites after browsing cooking recipe sites scattered on a network, the user can order in a short time using an intuitive interface. A user can accept a service without limitation on selecting a job (cooking dish), because all of job method provider sites (cooking recipe provider sites) and job component provider sites (foodstuff provider sites) on a network can be utilize.

To solve the above object, according to this invention, a coordination service system which includes a service system comprising a plurality of job method provider terminals for providing information Web pages for a predetermined job method, a plurality of job component provider terminals for providing job components necessary to perform the predetermined job method and for settling an account of a payment for the job components, and delivery service terminal for delivering the job components, the job method provider terminals, the job component provider terminals and the delivery service terminal being connected to a user terminal via a computer network, characterized by further comprising: a coordination terminal for ordering the job components, on the information Web pages of the predetermined job method, browsed by the user, directly from the job component provider terminal, and for ordering to collect and deliver the job components from the delivery service terminal, is provided.

In this invention, a terminal (coordination terminal) for coordinating a plurality of provider sites to provide predetermined job methods and a plurality of provider sites to provide job components such as materials or tools is located on a network. When the predetermined job method provider site (for example, cooking recipe sites) responsive to a request of a user is displayed, a button for indicating an intention of ordering job components (for example, foodstuffs), such as materials or tools, required for the predetermined job may be additionally displayed on a part of a screen, for example. If so a user can automatically extract foodstuffs required for the selected dish from a foodstuff provider terminal and order them, by means of selecting and determining a dish from cooking recipes and pressing the foodstuff ordering button, for example. As this coordination terminal does not required for holding a database of cooking recipes and a database of foodstuffs, for example, the coordination terminal does not required for a function of searching cooking recipes and foodstuffs. According to that system, as there is no necessity that a user browses foodstuff provider sites after browsing cooking recipe sites scattered on a network, the user can order in a short time using an intuitive interface. A user can accept a service without limitation on selecting a job (cooking dish), because all of job method provider sites (cooking recipe provider sites) and job component provider sites (foodstuff provider sites) on a network can be utilize. Moreover, even when a foodstuff provider does not provide a delivery service system, the provider can join a coordination service system according to this embodiment.

To solve the above object, according to this invention, a coordination service system which includes a service system comprising a plurality of job method provider terminals for providing information Web pages for a predetermined job method, a plurality of job component provider terminals for providing job components necessary to perform the predetermined job method, delivery service terminal for delivering the job components, the job method provider terminals, and an accounting agent terminal for settling an account of a payment for the job components, the job component provider terminals, the delivery service terminal and the accounting agent terminal being connected to a user terminal via a computer network, characterized by further comprising: a coordination terminal for ordering the job components, on the information Web pages of the predetermined job method, browsed by the user, directly from the job component provider terminal, for ordering to collect and deliver the job components from the delivery service terminal and for requesting to the accounting agent terminal for settling an account of a payment for the job components, is provided.

In this invention, a terminal (coordination terminal) for coordinating a plurality of provider sites to provide predetermined job methods and a plurality of provider sites to provide job components such as materials or tools is located on a network. When the predetermined job method provider site (for example, cooking recipe sites) responsive to a request of a user is displayed, a button for indicating an intention of ordering job components (for example, foodstuffs), such as materials or tools, required for the predetermined job may be additionally displayed on a part of a screen, for example. If so a user can automatically extract foodstuffs required for the selected dish from a foodstuff provider terminal and order them, by means of selecting and determining a dish from cooking recipes and pressing the foodstuff ordering button, for example. As this coordination terminal does not required for holding a database of cooking recipes and a database of foodstuffs, for example, the coordination terminal does not required for a function of searching cooking recipes and foodstuffs. According to that system, as there is no necessity that a user browses foodstuff provider sites after browsing cooking recipe sites scattered on a network, the user can order in a short time using an intuitive interface. A user can accept a service without limitation on selecting a job (cooking dish), because all of job method provider sites (cooking recipe provider sites) and job component provider sites (foodstuff provider sites) on a network can be utilize. Moreover, even when a foodstuff provider does not provide a delivery service system or a account agent system, the provider can join a coordination service system according to this embodiment.

Since the system according to this invention constructs that the coordination terminal includes a privacy leakage preventing means for preventing from leaking out personal data other than data necessary for the job component provider and the delivery service, the order from the job component provider terminal and the delivery service terminal performing by way of the privacy leakage preventing means, the personal data unnecessary for those providers can be kept in secret. For example, since the foodstuff provider is not informed of personal data, such as a destination address, information about a purchaser can be kept in secret. Since the delivery service provider is not informed of contents of delivered goods, information about purchased goods of a user can be kept in secret.

Since the system according to this invention constructs that the coordination terminal includes a means for ordering from the job component provider having delivery service system so as to deliver the job components, user can obtain job components such as materials or tools, only by ordering from the job component provider for providing materials or tools.

Since the system according to this invention constructs that the coordination terminal includes a means for ordering from the job component provider so as to settle electronically an account of a payment for the job components, a user can settle an account of a payment for the job components such as materials or tools online. Since the system according to this invention constructs that the coordination terminal includes a means for ordering from the job component provider so as to collect a payment for the job components when delivering it to the user, a user can pay for an order of the user even if the user does not use electronic settlement utilizing a credit card or the like, therefore the user can utilize the system. Since the system according to this invention constructs that the coordination terminal includes a means for ordering from the job component provider so as to collect a payment for the job components on handing it to the user at a shop of the job component provider, a user can pay for an order of the user even if the user does not use electronic settlement utilizing a credit card or the like, therefore the user can utilize the system.

Since the system according to this invention constructs that the coordination terminal includes a means for presenting required the job components extracted from the information Web pages for the predetermined job method browsed by the user, a businessman who manages the coordination terminal reduces the choices or selective items for ordering or changes the presented contents at every user in accordance with accumulated personal data, therefore the personalized business can be performed.

Since the system according to this invention constructs that the coordination terminal includes: a means for requesting a plurality of the job method provider terminal to send a list of the job components required for the predetermined job method; and a means for presenting the list of the job components, which are sent, on the user terminal, a user can select required job components such as materials or tools by means of selecting the corresponding portion from a list.

Since the system according to this invention constructs that the coordination terminal includes a means for selecting at least one job component required for the user from the job components presented, a user can select only required job components such as materials or tools by means of selecting the corresponding portion and omitting the unnecessary portion from listed job components of materials, tools or the like.

Since the system according to this invention constructs that the coordination terminal includes: a means for sending a first information of the job components, which are required, to the plurality of job component provider terminal; and a means for presenting a second information of the job component providers, which respond to the first information sent with being available to provide all of or a part of the job components, and the job components on the user terminal, an information about the providers which certainly provide materials or tools can be obtained.

Since the system according to this invention constructs that the coordination terminal includes a means for selecting at least one job component provider which is to be ordered by the user from among the job component providers, the providers which certainly provide materials or tools can be selected.

Since the system according to this invention constructs that the coordination terminal includes a means for selecting at least one job component provider which is to be ordered by the user based on a priority predefined by the user from among the job component providers, user can select the providers which provide job components corresponding to criteria for selection such as providers with low prices, providers with high qualities, providers with a short distance or the like.

Since the system according to this invention constructs that a plurality of job component provider is selected by the selecting means, a user can get a complete set of job components from the plurality of job providers and certainly obtain job components such as materials and tools, even if all the job components such as materials and tools can not be provided only by one job component provider terminal.

Since the system according to this invention constructs that the coordination terminal includes a means for presenting an amount of the job component ordered in unit that handled by the job component provider, amounts or prices of job components such as materials or tools is clearly expressed based on units of trade by the job component provider.

### BRIEF DESCRIPTION OF THE DRAWING

The above and other features of the invention and the concomitant advantages will be better understood and appreciated by persons skilled in the field to which the invention pertains in view of the following description given in conjunction with the accompanying drawings which illustrate preferred embodiments.

FIG. 1 is a block diagram showing a construction of a coordination service system according to a first embodiment of the present invention.

FIG. 2 is a flowchart showing a process flow of a user terminal in a coordination service system according to the first embodiment.

FIG. 3 is an explanatory diagram showing a URL list of recipe site of recipe provider terminal presented on a user terminal according to the first embodiment.

FIG. 4 is an explanatory diagram showing an example of a display screen of a menu of recipe provider site presented for browsing on a user terminal according to the first embodiment.

FIG. 5 is an explanatory diagram showing an example of a display screen of a foodstuff list required for cooking presented on a user terminal according to the first embodiment.

FIG. 6 is an explanatory diagram showing an example of a display screen of an order form and an example of a display screen of an order confirmation of a foodstuff provider presented on a user terminal according to the first embodiment.

FIG. 7 is a block diagram showing a construction of a coordination service system according to a second embodiment of the present invention.

FIG. 8 is a flowchart showing a process flow of a user terminal in a coordination service system according to the second embodiment.

FIG. 9 is an explanatory diagram showing an example of a display screen of a foodstuff order confirmation of a foodstuff provider presented on a user terminal according to the second embodiment.

FIG. 10 is an explanatory diagram showing an example of a display screen of a delivery order confirmation of a delivery service provider presented on a user terminal according to the second embodiment.

FIG. 11 is a block diagram showing a construction of a coordination service system according to a third embodiment of the present invention.

FIG. 12 is a flowchart showing a process flow of a user terminal in a coordination service system according to the third embodiment.

FIG. 13 is an explanatory diagram showing an example of a display screen of a foodstuff order confirmation of a foodstuff provider presented on a user terminal according to the third embodiment.

FIG. 14 is an explanatory diagram showing an example of a display screen of a delivery order confirmation of a delivery service provider presented on a user terminal according to the third embodiment.

FIG. 15 is an explanatory diagram showing an example of a display screen of a payment form of a utilization fee of an accounting agent presented on a user terminal according to the third embodiment.

FIG. 16 is a block diagram showing a construction of a coordination service system according to a fourth embodiment of the present invention.

FIG. 17 is a flowchart showing a process flow of a user terminal in a coordination service system according to the fourth embodiment.

FIG. 18 is an explanatory diagram showing an example of a display screen of a foodstuff order confirmation of a foodstuff provider presented on a user terminal according to the fourth embodiment.

### DETAILED DESCRIPTION OF THE EMBODIMENT

Hereinafter, the preferred embodiments of the present invention will be described in detail with reference to accompanying drawings. In the following description and accompanying drawings, the components with the same function and construction are denoted by the same reference numerals for omitting the repetition of the same description.

(First Embodiment)

As a first embodiment of the present invention, the coordination service system wherein a user operates to order predetermined foodstuffs after browsing a cooking recipe by way of a coordination terminal on a network, therefore the foodstuffs required for cooking are delivered to a designated destination address from a foodstuff provider and the user can pay for them simultaneously with the ordering operation is provided.

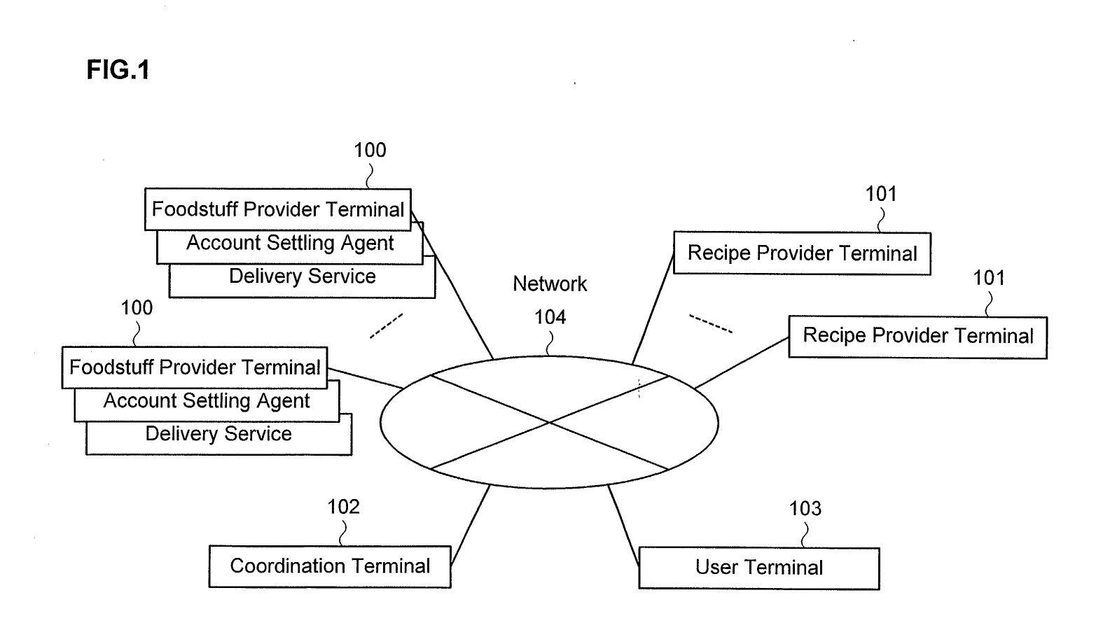

Referring now FIG. 1, the coordination service system according to the first embodiment of the present invention will be described hereinafter. FIG. 1 is a block diagram showing a construction of the coordination service system according to the first embodiment. The reference numeral 100 denotes a job component provider terminal (hereinafter, refers to as “a foodstuff provider terminal”) for presenting a list of foodstuffs and for accepting an order of foodstuffs, a delivery service and a settlement of payment. The reference numeral 101 denotes a job method provider terminal (hereinafter, refers to as “a recipe provider terminal”) for providing a cooking recipe. The reference numeral 102 denotes a coordination terminal for performing coordination. The reference numeral 103 denotes a user terminal and the reference numeral 104 denotes a network.

In the system of this embodiment, the foodstuff provider terminal 100 comprises a database storing names, prices, amounts and the like of foodstuffs, which can be provided. The foodstuff provider terminal 100 further comprises order-accepting system including a system that is capable of accepting an order by way of a network, a system for settling a payment and a system for delivering a foodstuff ordered to a designated address.

The recipe provider terminal 101 comprises a database storing names, ingredients, preparations and the like, and a system capable of browsing the cooking recipes by way of the network by a user.

The coordination terminal 102 has a function for storing personal data of users, information of foodstuff providers and information of recipe providers in a database, and a function for providing an user terminal 103 with a system capable of directly ordering ingredients, i.e., foodstuffs, by a cooking recipe.

The user terminal 103 connected to the network comprises a means for displaying information from the recipe provider terminal 101, information from the foodstuff provider terminal 100 or information from coordination terminal 102, and for inputting information in case of necessity. The network 104 connected with the terminals 100, 101, 102 and 103.

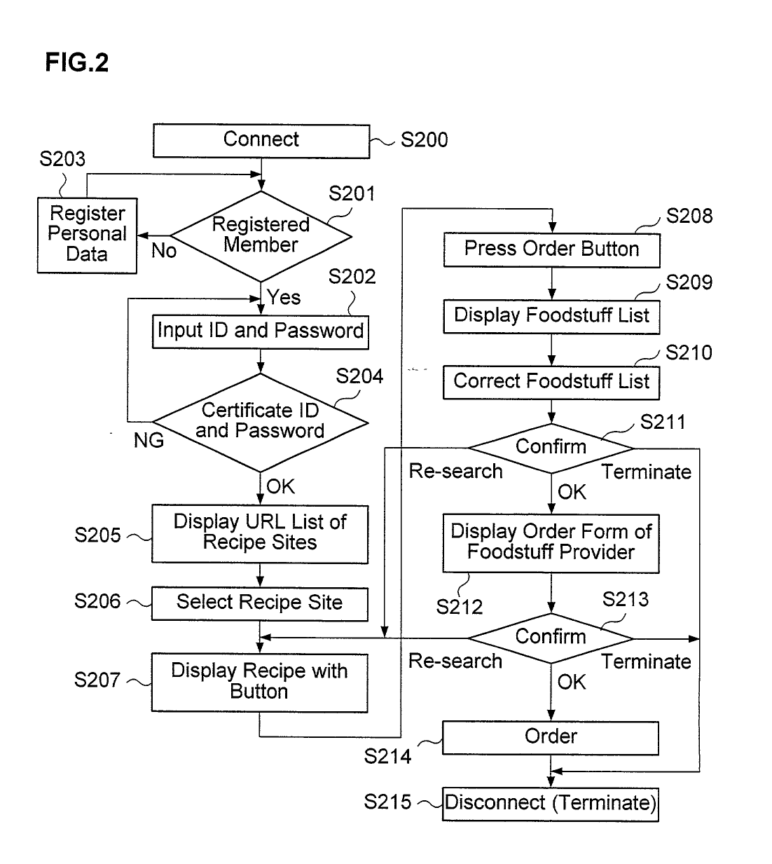

Referring now FIG. 2, a flow of an operation of the user terminal for the coordination service system according to the first embodiment of the present invention will be described hereinafter. FIG. 2 is a flowchart showing a operation process flow of a user terminal in a coordination service system according to the first embodiment.

In this embodiment, when a user intends to utilize the coordination service system, the user registers previously the personal data onto the coordination terminal 102. The user registers information that specifies an individual, and information such as a destination address for a delivery of a foodstuff, a number of a credit card or a bank account for a payment or the like. A method for registering the personal data does not restrict especially. Security of messages sent and received among terminals 100, 101, 102 and 103 by way of network 104 are protected entirely and an environment capable of sending and receiving messages safely is provided.

At first, in step S200, the user connects to the coordination terminal 102 by using the user terminal 103 (step S200). This corresponds to that the user designates the URL of the coordination terminal 102 by using a general-purpose Web browser.

Next, in step S201, the system determines whether the user is a registered member or not (step S201). In case of the user is determined as a registered member, the process advances to step S202 where a user name, password and the like is inputted (step S202), and, thereafter in step S204, the system determines whether the user name, password and the like inputted is correct or not (step S204).

In case of the system determines that user is not a registered member, the process switches to step S203, where a registration page is displayed for urging a registration (step S203).

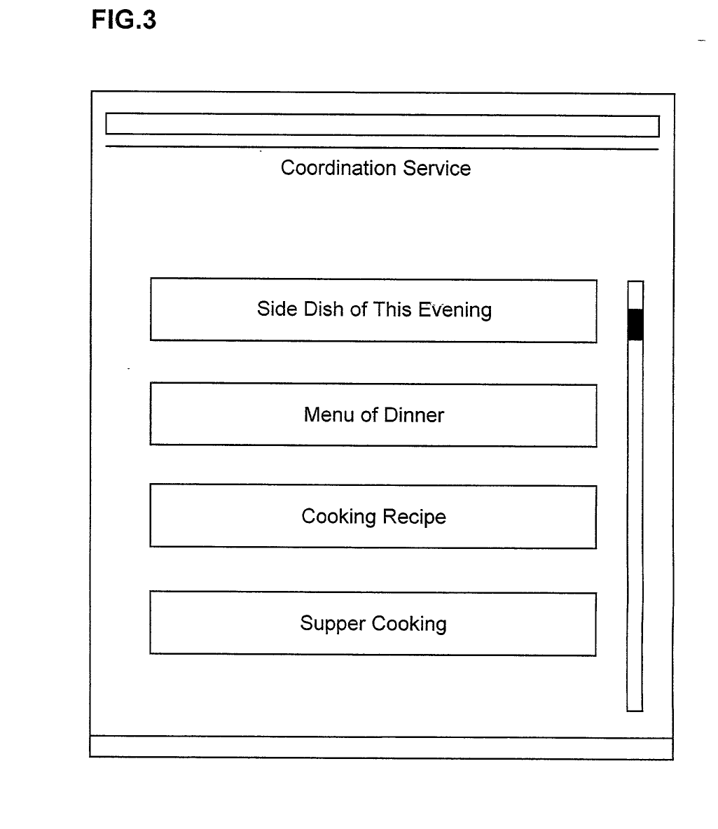

In step S204, the system determines the user name, password and the like inputted is correct, the process advances to step S205 where a page provided by the coordination terminal 102 is displayed (step S205). On this situation, the coordination terminal 102 presents a URL list of a plurality of terminals that provides cooking recipes on the user terminal as shown in FIG. 3. This means that a URL of a site providing a cooking recipe is displayed within a page provided by the coordination terminal 102 as a URL link. This URL is displayed after associated previously with the cooking recipe provider.

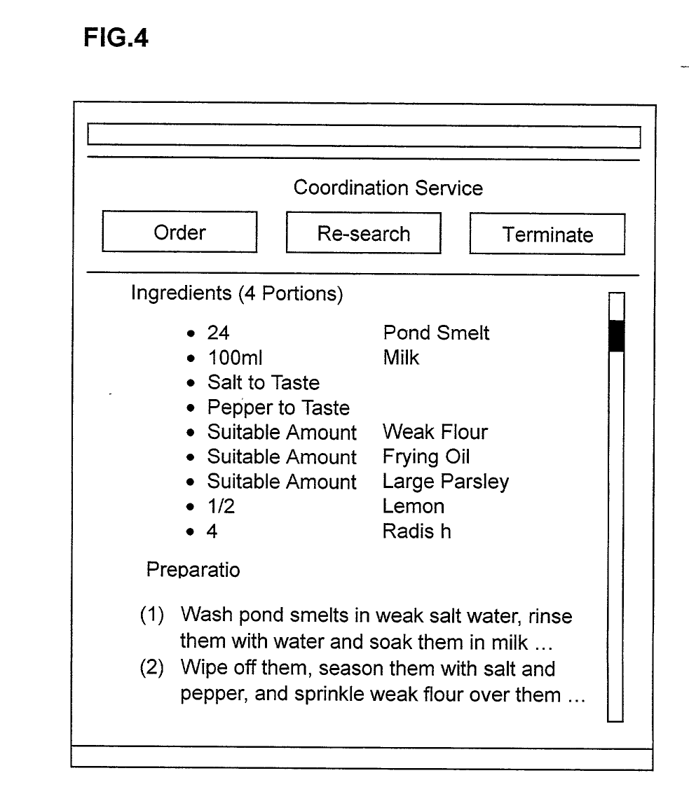

Next, in step S206, user selects the desired one site from the presented URL list of the plurality of terminals providing cooking recipes (step S206). Then, the process advances to step S207 where the user browses a recipe page provided by the selected terminal (step S207). On this situation, such as a foodstuff ordering button is displayed additively to a screen image presented by the recipe provider site within the same display screen on the user terminal 103 as shown in FIG. 4.

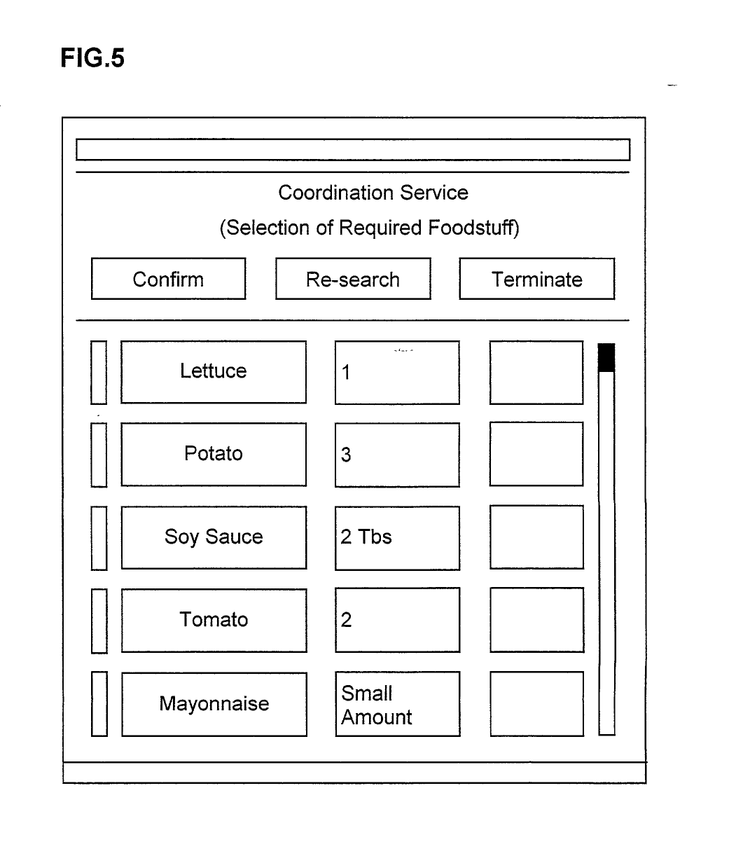

The user searches the required cooking recipe in the recipe provider site with a variety of searching methods. In step S208, if the user reached to the page for the required cooking recipe, then the user presses the foodstuff ordering button (step S208). By this operation, in step S209, the coordination terminal 102 presents a list of kinds and amounts of foodstuffs required for cooking the selected recipe on the user terminal 103 as shown in FIG. 5 (step S209).

As the method for obtaining the kinds and amounts of the foodstuffs required for cooking, extracting the corresponding part from the displayed cooking recipe or requesting the list of the ingredients of the selected cooking recipe to the recipe provider can be utilized.

Further, in step S210, user corrects the presented contents such as leaving only the required foodstuffs by deleting the unnecessary foodstuffs, or changing amounts of the foodstuffs (step S210). Thereafter, the process advances to step S211 where user presses a confirming button (step S211). Alternatively, canceling this operation and returning to the display for selection of the recipes can be selected.

Then the coordination terminal 102 selects the foodstuff provider terminal 100 which can provide the required foodstuffs and can deliver them to the destination designated by user in the designated time. If all the required foodstuffs could not be provided on a single foodstuff provider, a plurality of foodstuff provider terminals 100 could be selected. For selecting the foodstuff provider, the method that the coordination terminal 102 sends the information of the foodstuffs, the destination of delivery, the delivery time or the like to the foodstuff providers and selects the foodstuff provider that replied a capability of delivering the foodstuff in designated time can be employed. In case of there are a plurality of possibilities of the foodstuff provider, the method of selecting by user or the method for selecting according to the priority (such as the providers with low prices, providers with high qualities or the like) predetermined by user can also be employed.

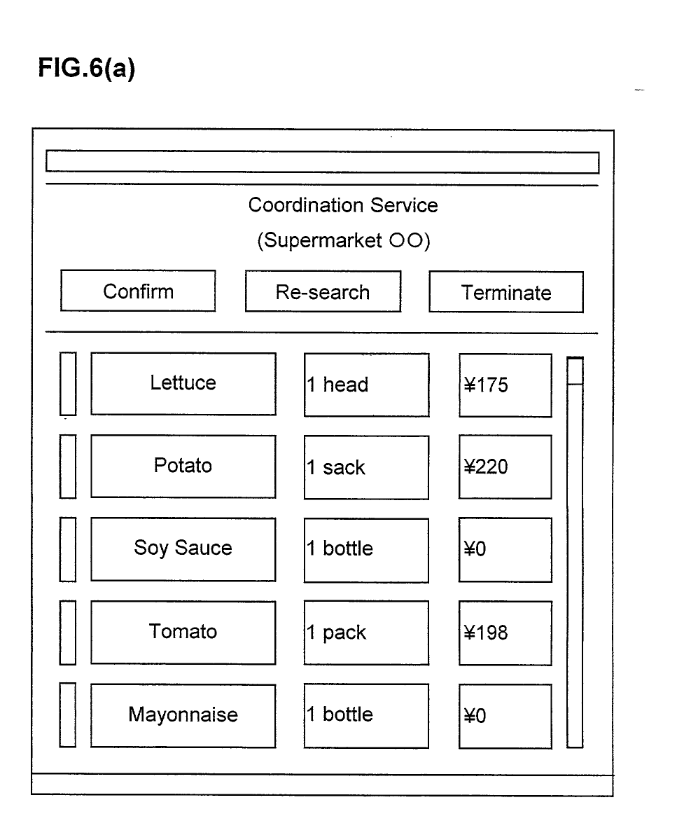

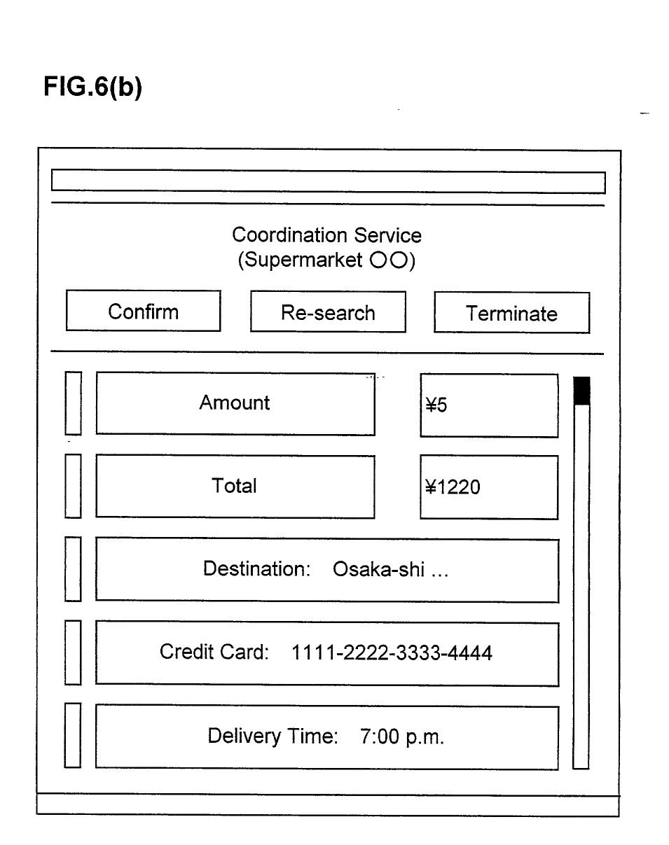

Thus, when the foodstuff provider is determined, the process advances to step S212 where the coordination terminal 102 obtains an order form from the selected foodstuff provider as shown in FIG. 6(a), the user fills the corresponding portions of the form with at least a part of the kinds of the foodstuffs ordered, amounts, prices, destination of delivery previously registered, delivery time, credit card number for payment and so forth, and presented on the user terminal 103 as shown in FIG. 6(b) (step S212). Where the amounts of the foodstuffs are displayed in unit of handling by the foodstuff provider enough for required amounts.

Next, the process advances to step S213 where the user confirms the contents of the order form and makes the required correction if any, and then user presses the confirmation button (step S213). Alternatively, canceling this operation and returning to the display for selection of the recipes, for example, can also be selected.

Furthermore, when the user press the confirmation button, the process advances to step S214 where the contents of the order form of the foodstuffs are sent to the foodstuff provider terminal 100 (step S214), and on step S215, the process for ordering is terminated (step S215). The foodstuff provider receives the order of the foodstuffs on the foodstuff provider terminal 100, and then acts for settling the account for payment and delivers the foodstuffs to the destination designated by the user.

In this embodiment described above, the payment system that the foodstuff provider acts for settlement the account by using such as the credit card is described as an example, however the system of exchanging the payment for the foodstuffs on delivery, i.e., cash on delivery, may be employed. At the process of step S209, if a plurality of cooking recipes have been selected already, the entire list of the kinds and amounts of the foodstuffs required for the recipes after summing up the kinds and amounts of the all foodstuffs may be presented on the user terminal 103. In the process of step S211, after confirming the required foodstuffs the process may return the display of the other recipe selection for adding the other cooking recipe. In the processes of steps S211 and S213, by re-searching or additively searching the process may return to step S205, instead of step S207, for starting with the selection of the recipe site.

As described above, since the coordination terminal according to this embodiment utilizes a database and a searching function of the recipe provider terminal, and a database, a searching function and an ordering function of the foodstuff provider terminal, the coordination terminal does not need to have a database of contents of cooking recipe and foodstuff, and a searching function, therefore easily constructs a coordination service system. Since the information of recipe sites and the information for providing foodstuff itself on a network can be utilized, the user can select recipe and foodstuff without restriction on a provider.

According to the system of this embodiment, since the user can directly order the required foodstuffs while browsing the cooking recipe, the period required for an online shopping is shortened, the connection charge for the network provider can be reduced, and therefore oversight of foodstuff order and extra order can be reduced.

A businessman who manages the coordination terminal reduces the choices or selective items for ordering or changes the presented contents at every user in accordance with accumulated personal data, and therefore the personalized business can be achieved.

(Second Embodiment)

As a second embodiment of the present invention, the coordination service system wherein a user operates to order predetermined foodstuffs after browsing a cooking recipe by way of a coordination terminal on a network, therefore the foodstuffs required for cooking are provided by a foodstuff provider, and a delivery service provider requested by way of a network collects the foodstuffs and delivers them to a destination address designated by the user is provided.

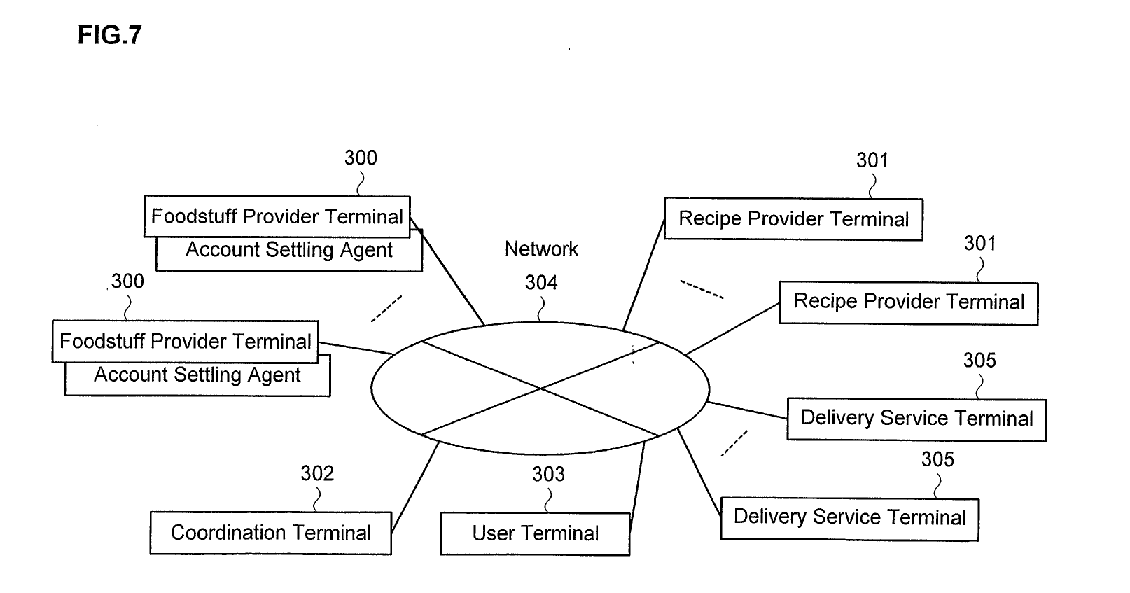

Referring now FIG. 7, the coordination service system according to the second embodiment of the present invention will be described hereinafter. FIG. 7 is a block diagram showing a construction of the coordination service system according to the second embodiment. The reference numeral 300 denotes a foodstuff provider terminal for presenting a list of foodstuffs, and for accepting an order of foodstuffs and a settlement of payment. The reference numeral 301 denotes a recipe provider terminal for providing a cooking recipe. The reference numeral 302 denotes a coordination terminal for performing coordination. The reference numeral 303 denotes a user terminal and the reference numeral 304 denotes a network. The reference numeral 305 denotes a delivery service provider terminal for a delivery service provider that collects the foodstuffs and delivers them to a destination designated the user.

In the system of this embodiment, the foodstuff provider terminal 300 comprises a database storing names, prices, amounts and the like of foodstuffs, which can be provided. The foodstuff provider terminal 300 further comprises order-accepting system including a system that is capable of accepting an order by way of a network and a system for acting to settle a payment.

The recipe provider terminal 301 comprises a database storing names, ingredients, preparations and the like, and a system capable of browsing the cooking recipes by way of the network by a user.

The coordination terminal 302 has a function for storing personal data of users, information of foodstuff providers, information of recipe providers and information of delivery service providers in a database, and a function for providing an user terminal 303 with a system capable of directly ordering ingredients, i.e., foodstuffs, by a cooking recipe.

The user terminal 303 connected to the network comprises a means for displaying information from the recipe provider terminal 301, information from the foodstuff provider terminal 300 or information from coordination terminal 302, and for inputting information in case of necessity.

The delivery service provider terminal 305 comprises a system for accepting an order of collection and delivery from the coordination terminal 302, and the delivery service provider collects the foodstuffs from the foodstuff provider and delivers them to a destination address designated from the user. The network 304 connected with the terminals 300, 301, 302, 303 and 305.

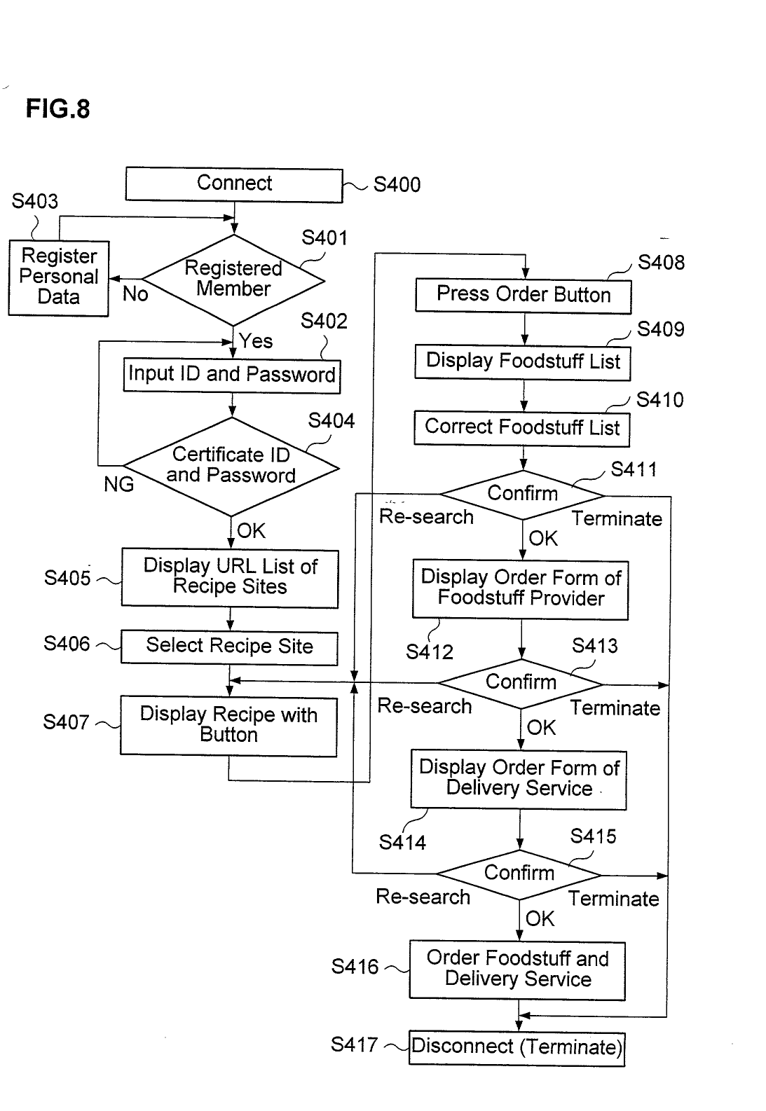

Referring now FIG. 8, a flow of an operation of the user terminal for the coordination service system according to the second embodiment of the present invention will be described hereinafter. FIG. 8 is a flowchart showing a operation process flow of a user terminal in a coordination service system according to the second embodiment.

In this embodiment, when a user intends to utilize the coordination service system, the user registers previously the personal data onto the coordination terminal 302. The user registers information that specifies an individual, and information such as a destination address for a delivery of a foodstuff, a number of a credit card or a bank account for a payment or the like. A method for registering the personal data does not restrict especially. Security of messages sent and received among terminals 300, 301, 302, 303 and 305 by way of network 304 are protected entirely and an environment capable of sending and receiving messages safely is provided.

At first, in step S400, the user connects to the coordination terminal 302 by using the user terminal 303 (step S400). This corresponds to that the user designates the URL of the coordination terminal 302 by using a general-purpose Web browser.

Next, in step S401, the system determines whether the user is a registered member or not (step S401). In case of the user is determined as a registered member, the process advances to step S401 where a user name, password and the like is inputted (step S402), and, thereafter in step S404, the system determines whether the user name, password and the like inputted is correct or not (step S404).

In case of the system determines that user is not a registered member, the process switches to step S403, where a registration page is displayed for urging a registration (step S403).

In step S404, the system determines the user name, password and the like inputted is correct, the process advances to step S405 where a page provided by the coordination terminal is displayed (step S405). On this situation, the coordination terminal 302 presents a URL list of a plurality of terminals 301 that provides cooking recipes on the user terminal as shown in FIG. 3. This means that a URL of a site providing a cooking recipe is displayed within a page provided by the coordination terminal 302 as a URL link. This URL is displayed after associated previously with the cooking recipe provider.

Next, in step S406, user selects the desired one site from the presented URL list of the plurality of terminals providing cooking recipes (step S406). Then, the process advances to step S407 where the user browses a recipe page provided by the selected terminal. On this situation, such as a foodstuff ordering button is displayed additively to a screen image presented by the recipe provider site within the same display screen on the user terminal 503 as shown in FIG. 4.

The user searches the required cooking recipe in the recipe provider site with a variety of searching methods. In step S408, if the user reached to the page for the required cooking recipe, then the user presses the foodstuff ordering button (step S408). By this operation, in step S409, the coordination terminal 302 presents a list of kinds and amounts of foodstuffs required for cooking the selected recipe on the user terminal 303 as shown in FIG. 5 (step S409).

As the method for obtaining the kinds and amounts of the foodstuffs required for cooking, extracting the corresponding part from the displayed cooking recipe or requesting the list of the ingredients of the selected cooking recipe to the recipe provider can be utilized.

Further, in step S410, user corrects the presented contents such as leaving only the required foodstuffs by deleting the unnecessary foodstuffs, or changing amounts of the foodstuffs (step S410). Thereafter, the process advances to step S411 where user presses a confirming button (step S411). Alternatively, canceling this operation and returning to the display for selection of the recipes can be selected.

Then the coordination terminal 302 selects the foodstuff provider terminal 300 which can provide the required foodstuffs. If all the required foodstuffs could not be provided on a single foodstuff provider, a plurality of foodstuff provider terminals 300 could be selected. For selecting the foodstuff provider, the method that the coordination terminal 302 sends the information of the foodstuffs to the foodstuff providers and selects the foodstuff provider that replied a capability of providing all or a part of the foodstuff can be employed. In case of there are a plurality of possibilities of the foodstuff provider, the method of selecting by user or the method for selecting according to the priority (such as the providers with low prices, providers with high qualities or the like) predetermined by user can also be employed.

In this embodiment, at the same time, the coordination terminal 302 selects the delivery service provider terminal 305 which can deliver the foodstuffs to the destination designated by user in the designated time. For selecting the delivery service provider, the method that the coordination terminal 302 sends the destination of delivery, the delivery time or the like to the delivery service providers and selects the delivery service provider that replied a capability of delivering the foodstuff in designated time can be employed. In case of there are a plurality of possibilities of the delivery service provider, the method of selecting by user or the method for selecting according to the priority (such as the providers with low prices or the like) predetermined by user can also be employed.

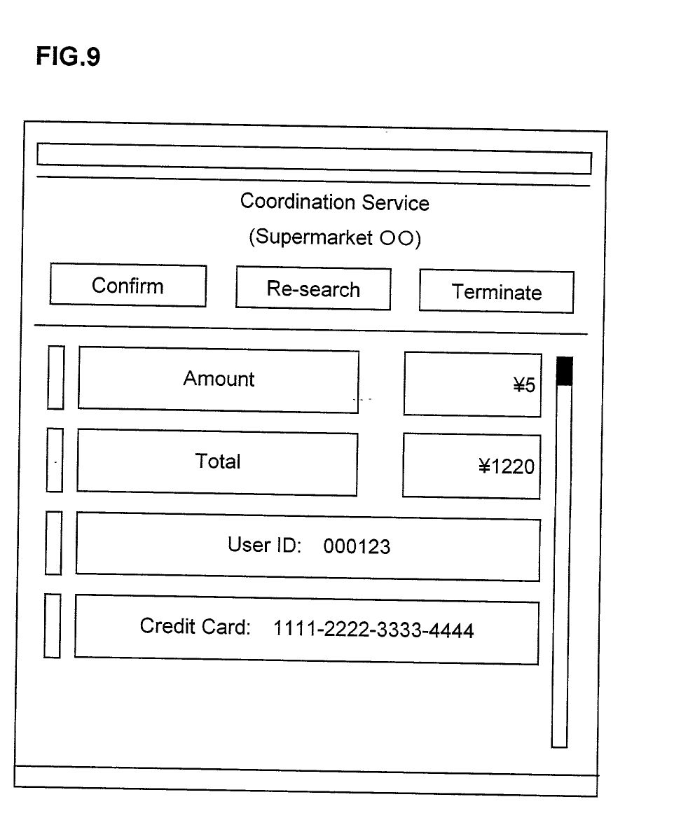

Thus, when the foodstuff provider and the delivery service provider are determined, the process advances to step S412 where the coordination terminal 302 obtains an order form from the selected foodstuff provider as shown in FIG. 6(a), the user fills the corresponding portions of the form with at least a part of the kinds of the foodstuffs ordered, amounts, prices, credit card number for payment and so forth, and presented on the user terminal 803 as shown in FIG. 9 (step S412). Where the amounts of the foodstuffs are displayed in unit of handling by the foodstuff provider enough for required amounts.

Next, the process advances to step S413 where the user confirms the contents of the order form and makes the required correction if any, and then user presses the confirmation button (step S413). Alternatively, canceling this operation and returning to the display for selection of the recipes, for example, can also be selected.

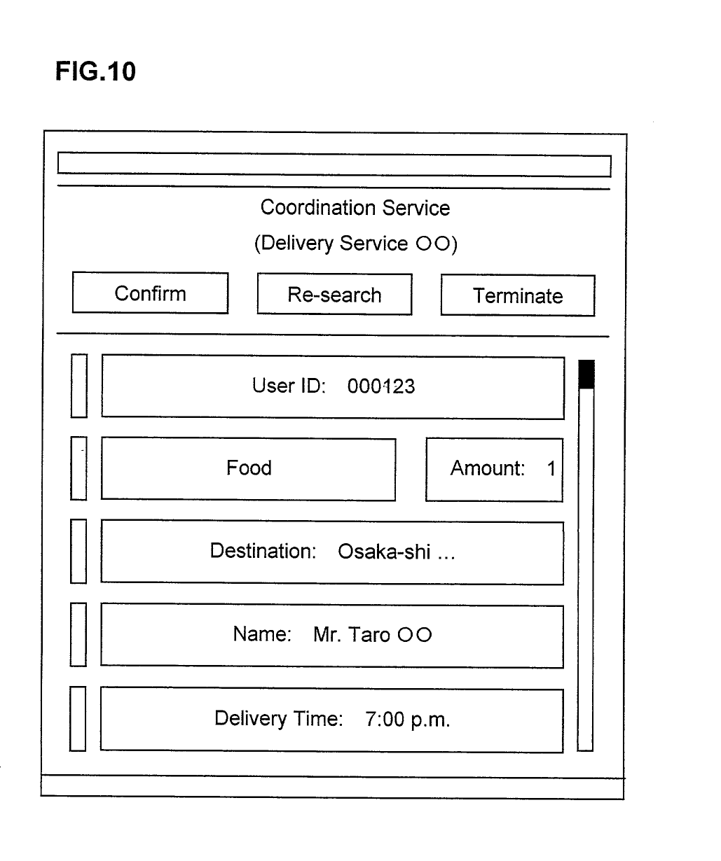

Then, in step S414, the coordination terminal 302 obtains an order form from the selected delivery service provider, the user fills the corresponding portions of the form with at least a part of collecting place, destination of delivery previously registered, delivery time and so forth, and presented on the user terminal 303 as shown in FIG. 10 (step S414). Next, the process advances to step S415 where the user confirms the contents of the delivery form and makes the required correction if any, and then user presses the confirmation button (step S415). Alternatively, canceling this operation and returning to the display for selection of the recipes, for example, can also be selected.

Furthermore, when the user press the confirmation button, the process advances to step S416 where the contents of the order form of the foodstuffs are sent to the foodstuff provider terminal 300 and at the same time the contents of the order form of the delivery are sent to the delivery service provider terminal 305 (step S416), and on step S417, the process for ordering is terminated (step S417).

The foodstuff provider receives the order of the foodstuffs on the foodstuff provider terminal 300, provides the foodstuffs and then acts for settling the account for payment. Where, since only the contents of the foodstuffs and the credit card number transmitted to the foodstuff provider, the individual user is not specified.

On the other hand, the delivery service provider receives the order of the delivery on the delivery service provider terminal 305, and then collects the foodstuffs and delivers the foodstuffs to the destination designated by the user corresponding to the contents of the delivery.

In this embodiment described above, the system comprises the delivery service provider independent of the foodstuff provider is described, however this system can incorporate with the system of the foodstuff provider itself providing the delivery service. The payment system that the foodstuff provider acts for settlement the account by using such as the credit card is described as an example, however the system of exchanging the payment for the foodstuffs on delivery, i.e., cash on delivery, may be employed. Furthermore, the system can use in the environment containing a terminal for electronic settlement, a terminal for acceptance of the delivery order and the like. At the process of step S409, if a plurality of cooking recipes have been selected already, the entire list of the kinds and amounts of the foodstuffs required for the recipes after summing up the kinds and amounts of the all foodstuffs may be presented on the user terminal 303. In the process of step S411, after confirming the required foodstuffs the process may return the display of the other recipe selection for adding the other cooking recipe. In the processes of steps S411, S413 and S415, by re-searching or additively searching the process may return to step S405, instead of step S407, for starting with the selection of the recipe site.

As described above, since the coordination terminal according to this embodiment utilizes a database and a searching function of the recipe provider terminal, and a database, a searching function and an ordering function of the foodstuff provider terminal, the coordination terminal does not need to have a database of contents of cooking recipe and foodstuff, and a searching function, therefore easily constructs a coordination service system. Since the information of recipe sites and the information for providing foodstuff itself on a network can be utilized, the user can select recipe and foodstuff without restriction on a provider.

According to the system of this embodiment, since the user can directly order the required foodstuffs while browsing the cooking recipe, the period required for an online shopping is shortened, the connection charge for the network provider can be reduced, and therefore oversight of foodstuff order and extra order can be reduced.

A businessman who manages the coordination terminal reduces the choices or selective items for ordering or changes the presented contents at every user in accordance with accumulated personal data, and therefore the personalized business can be achieved.

Furthermore, since the system according to this embodiment comprises the delivery service provider terminal connected with the coordination terminal, even the foodstuff provider without the delivery service system can also join the system. When the foodstuffs are ordered by way of coordination terminal, the personal data such as the deliver destination are not transmitted to the foodstuff provider and the personal data specifying the user purchased the foodstuffs can keep in secret. On the other hand, the contents of delivery are not transmitted to the delivery service provider and the personal data specifying the purchased goods can keep in secret.

(Third Embodiment)

As a third embodiment of the present invention, the coordination service system wherein a user operates to order predetermined foodstuffs after browsing a cooking recipe by way of a coordination terminal on a network, therefore the foodstuffs required for cooking are provided by a foodstuff provider, a delivery service provider requested by way of a network collects the foodstuffs and delivers them to a destination address designated by the user, and an account settling agent acts a settlement of account for the foodstuff provider is provided.

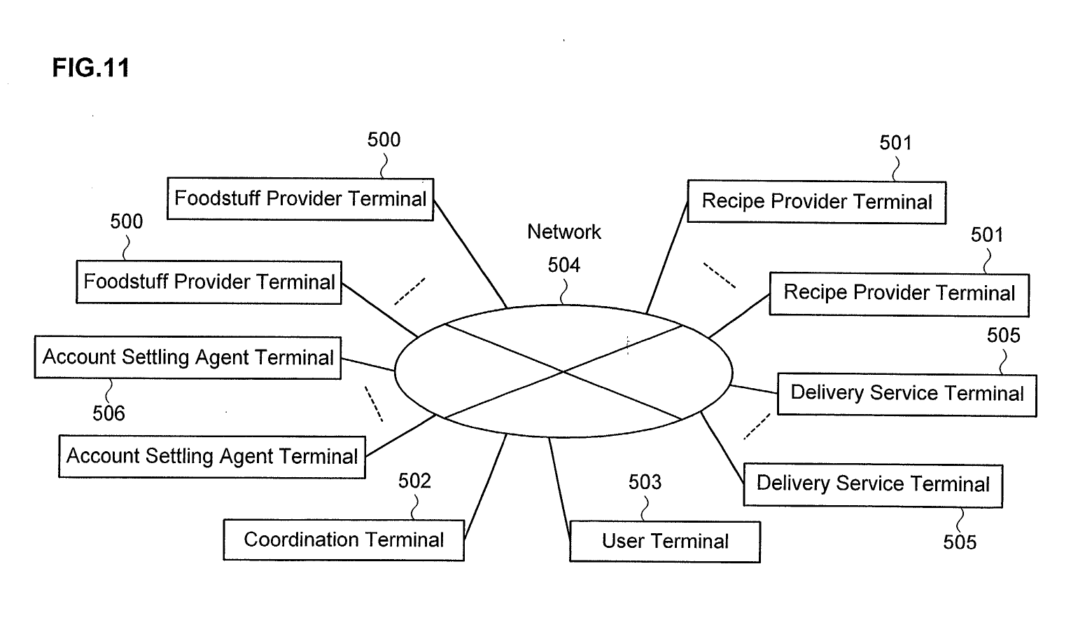

Referring now FIG. 11, the coordination service system according to the third embodiment of the present invention will be described hereinafter. FIG. 11 is a block diagram showing a construction of the coordination service system according to the third embodiment. The reference numeral 500 denotes a foodstuff provider terminal for presenting a list of foodstuffs and for accepting an order of foodstuffs. The reference numeral 501 denotes a recipe provider terminal for providing a cooking recipe. The reference numeral 502 denotes a coordination terminal for performing coordination. The reference numeral 503 denotes a user terminal and the reference numeral 504 denotes a network. The reference numeral 505 denotes a delivery service provider terminal for a delivery service provider that collects the foodstuffs and delivers them to a destination designated the user. The reference numeral 506 denotes a account settling agent terminal for a settling agent that settles the payment for the foodstuff provider from the user.

In the system of this embodiment, the foodstuff provider terminal 500 comprises a database storing names, prices, amounts and the like of foodstuffs, which can be provided. The foodstuff provider terminal 500 further comprises order-accepting system including a system that is capable of accepting an order by way of a network.

The recipe provider terminal 501 comprises a database storing names, ingredients, preparations and the like, and a system capable of browsing the cooking recipes by way of the network by a user.

The coordination terminal 502 has a function for storing personal data of users, information of foodstuff providers, information of recipe providers, information of delivery service providers and information of account settling agents in a database, and a function for providing an user terminal 503 with a system capable of directly ordering ingredients, i.e., foodstuffs, by a cooking recipe.

The user terminal 503 connected to the network comprises a means for displaying information from the recipe provider terminal 501, information from the foodstuff provider terminal 500 or information from coordination terminal 502, and for inputting information in case of necessity.

The delivery service provider terminal 505 comprises a system for accepting an order of collection and delivery from the coordination terminal 502, and the delivery service provider collects the foodstuffs from the foodstuff provider and delivers them to a destination address designated from the user.

The account settling agent terminal 506 comprises a system for accepting a payment for the user and information of the foodstuff provider from the coordination terminal 502, and capable of paying from an account of the user and remitting the predetermined remittance to a designated account of the foodstuff provider. The network 504 connected with the terminals 500, 501, 502, 503, 505 and 506.

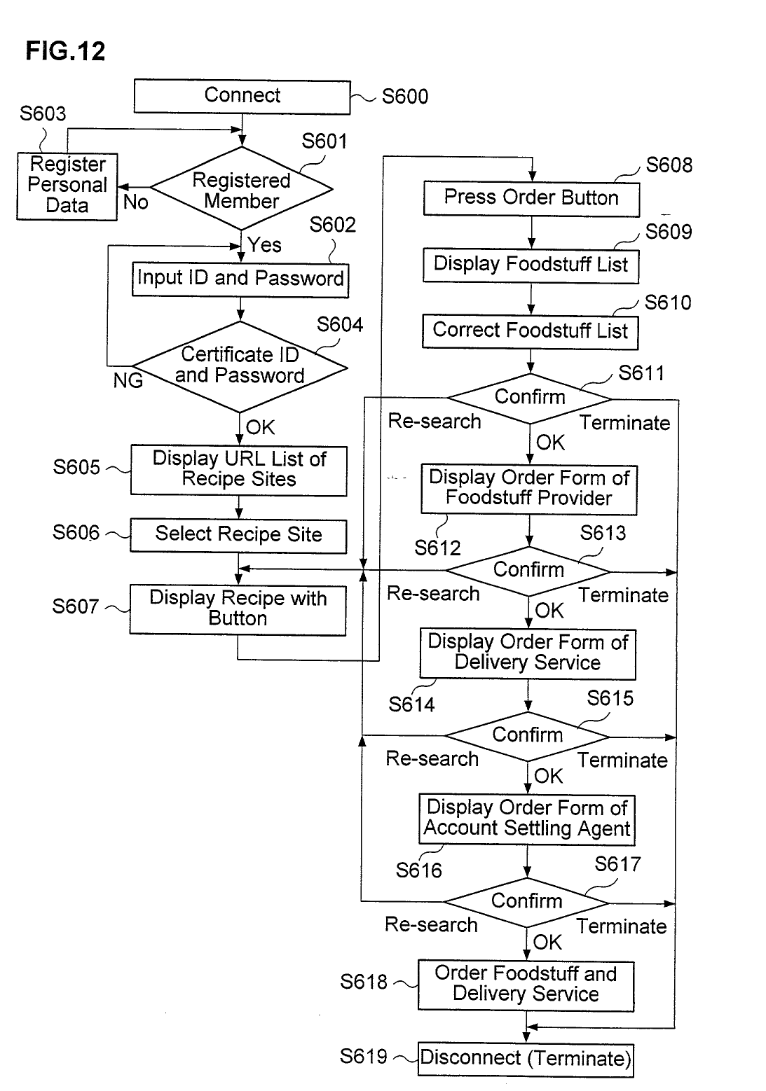

Referring now FIG. 12, a flow of an operation of the user terminal for the coordination service system according to the third embodiment of the present invention will be described hereinafter. FIG. 12 is a flowchart showing a operation process flow of a user terminal in a coordination service system according to the third embodiment.

In this embodiment, when a user intends to utilize the coordination service system, the user registers previously the personal data onto the coordination terminal 502. The user registers information that specifies an individual, and information such as a destination address for a delivery of a foodstuff, a number of a credit card or a bank account for a payment or the like. A method for registering the personal data does not restrict especially. Security of messages sent and received among terminals 500, 501, 502, 503, 505 and 506 by way of network 504 are protected entirely and an environment capable of sending and receiving messages safely is provided.

At first, in step S600, the user connects to the coordination terminal 502 by using the user terminal 503 (step S600). This corresponds to that the user designates the URL of the coordination terminal 502 by using a general-purpose Web browser.

Next, in step S601, the system determines whether the user is a registered member or not (step S601). In case of the user is determined as a registered member, the process advances to step S602 where a user name, password and the like is inputted (step S602), and, thereafter in step S604, the system determines whether the user name, password and the like inputted is correct or not (step S604).

In case of the system determines that user is not a registered member, the process switches to step S603, where a registration page is displayed for urging a registration (step S603).

In step S604, the system determines the user name, password and the like inputted is correct, the process advances to step S605 where a page provided by the coordination terminal is displayed (step S605). On this situation, the coordination terminal 502 presents a URL list of a plurality of terminals that provides cooking recipes on the user terminal as shown in FIG. 3 (step S605). This means that a URL of a site providing a cooking recipe is displayed within a page provided by the coordination terminal 502 as a URL link. This URL is displayed after associated previously with the cooking recipe provider.

Next, in step S606, user selects the desired one site from the presented URL list of the plurality of terminals providing cooking recipes (step S606). Then, the process advances to step S607 where the user browses a recipe page provided by the selected terminal (step S607). On this situation, such as a foodstuff ordering button is displayed additively to a screen image presented by the recipe provider site within the same display screen on the user terminal 503 as shown in FIG. 4.

The user searches the required cooking recipe in the recipe provider site with a variety of searching methods. In step S608, if the user reached to the page for the required cooking recipe, then the user presses the foodstuff ordering button (step S608). By this operation, in step S609, the coordination terminal 502 presents a list of kinds and amounts of foodstuffs required for cooking the selected recipe on the user terminal 503 as shown in FIG. 5 (step S609).

As the method for obtaining the kinds and amounts of the foodstuffs required for cooking, extracting the corresponding part from the displayed cooking recipe or requesting the list of the ingredients of the selected cooking recipe to the recipe provider can be utilized.

Further, in step S610, user corrects the presented contents such as leaving only the required foodstuffs by deleting the unnecessary foodstuffs, or changing amounts of the foodstuffs (step S610). Thereafter, the process advances to step S611 where user presses a confirming button (step S611). Alternatively, canceling this operation and returning to the display for selection of the recipes can be selected.

Then the coordination terminal 502 selects the foodstuff provider terminal 500 which can provide the required foodstuffs. If all the required foodstuffs could not be provided on a single foodstuff provider, a plurality of foodstuff provider terminals 500 could be selected. For selecting the foodstuff provider, the method that the coordination terminal 502 sends the information of the foodstuffs to the foodstuff providers and selects the foodstuff provider that replied a capability of providing all or a part of the foodstuff can be employed. In case of there are a plurality of possibilities of the foodstuff provider, the method of selecting by user or the method for selecting according to the priority (such as the providers with low prices, providers with high qualities or the like) predetermined by user can also be employed.

At the same time, the coordination terminal 502 selects the delivery service provider terminal 505 which can deliver the foodstuffs to the destination designated by user in the designated time. For selecting the delivery service provider, the method that the coordination terminal 502 sends the destination of delivery, the delivery time or the like to the delivery service providers and selects the delivery service provider that replied a capability of delivering the foodstuff in designated time can be employed. In case of there are a plurality of possibilities of the delivery service provider, the method of selecting by user or the method for selecting according to the priority (such as the providers with low prices or the like) predetermined by user can also be employed.

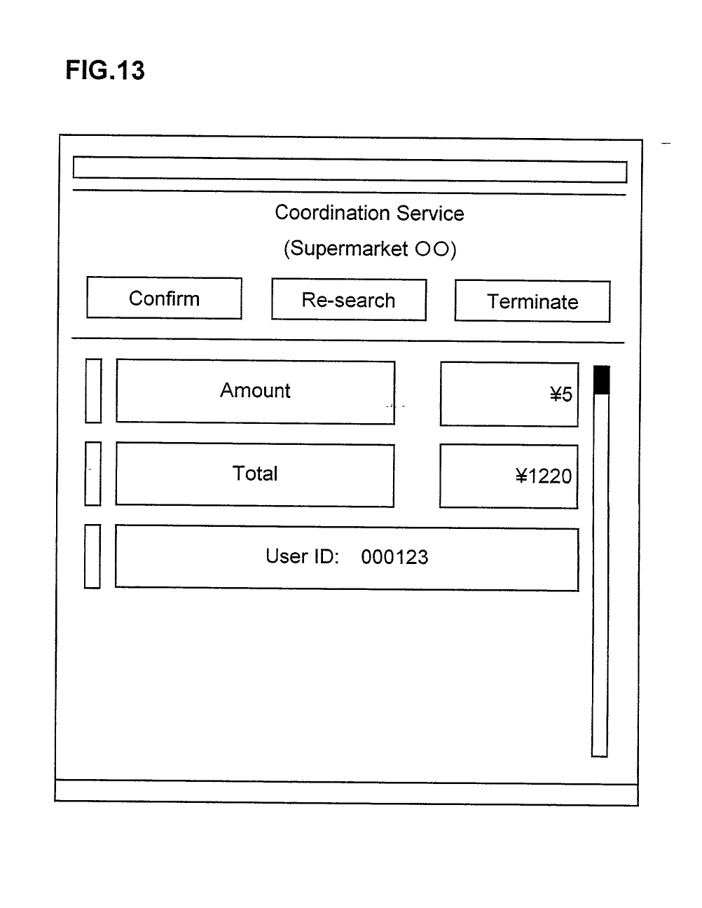

Thus, when the foodstuff provider and the delivery service provider are determined, the process advances to step S612 where the coordination terminal 502 obtains an order form from the selected foodstuff provider as shown in FIG. 6(a), the user fills the corresponding portions of the form with at least a part of the kinds of the foodstuffs ordered, amounts and so forth, and presented on the user terminal 503 as shown in FIG. 13 (step S612). Where the amounts of the foodstuffs are displayed in unit of handling by the foodstuff provider enough for required amounts.

Next, the process advances to step S613 where the user confirms the contents of the order form and makes the required correction if any, and then user presses the confirmation button (step S613). Alternatively, canceling this operation and returning to the display for selection of the recipes, for example, can also be selected.

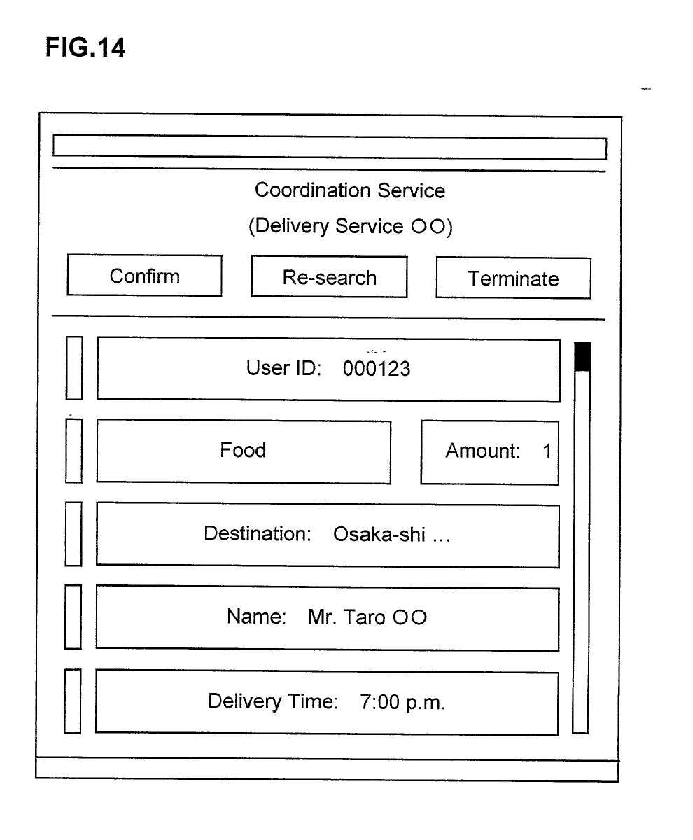

Then, in step S614, the coordination terminal 502 obtains an order form from the selected delivery service provider, the user fills the corresponding portions of the form with at least a part of collecting place, destination of delivery previously registered, delivery time and so forth, and presented on the user terminal 503 as shown in FIG. 14 (step S614). Next, the process advances to step S615 where the user confirms the contents of the delivery form and makes the required correction if any, and then user presses the confirmation button (step S615). Alternatively, canceling this operation and returning to the display for selection of the recipes, for example, can also be selected.

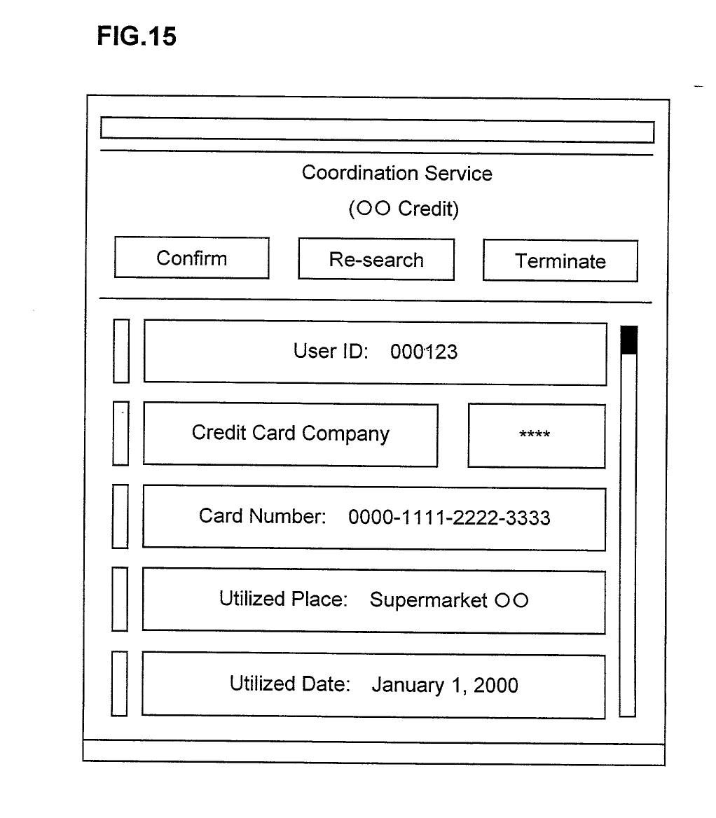

At the same time, in step S616, the coordination terminal 502 receives a payment form from the selected account settling agent terminal 506, the user fills the corresponding portions of the form with at least a part of payment, the number of the account of the foodstuff provider, the number of the account or the credit card of the user and so forth, and presented on the user terminal 503 as shown in FIG. 15 (step S616). Next, the process advances to step S617 where the user confirms the contents of the form and makes the required correction if any, and then user presses the confirmation button (step S617). Alternatively, canceling this operation and returning to the display for selection of the recipes, for example, can also be selected.

Furthermore, when the user press the confirmation button, the process advances to step S618 where the contents of the order form of the foodstuffs are sent to the foodstuff provider terminal 500 and at the same time the contents of the order form of the delivery are sent to the delivery service provider terminal 505 (step S618), and on step S619, the process for ordering is terminated (step S619).

The foodstuff provider receives the order of the foodstuffs on the foodstuff provider terminal 500, provides the foodstuffs and then acts for settling the account for payment. The delivery service provider receives the order of the delivery on the delivery service provider terminal 505, and then collects the foodstuffs and delivers the foodstuffs to the destination designated by the user corresponding to the contents of the delivery. The account settling agent receives the contents of the payment in the system on the account settling agent terminal 506, and then pays from an account of the user and remitting the predetermined remittance to a designated account of the foodstuff provider.

In this embodiment described above, the system comprises the delivery service provider independent of the foodstuff provider is described, however this system can incorporate with the system of the foodstuff provider itself providing the delivery service. The system comprises the account settling agent independent of the foodstuff provider is described, however this system can incorporate with the system of the foodstuff provider itself providing the account settlement agent service or the system of the delivery service provider providing the account settlement agent service.

As described above, since the coordination terminal according to this embodiment utilizes a database and a searching function of the recipe provider terminal, and a database, a searching function and an ordering function of the foodstuff provider terminal, the coordination terminal does not need to have a database of contents of cooking recipe and foodstuff, and a searching function, therefore easily constructs a coordination service system. Since the information of recipe sites and the information for providing foodstuff itself on a network can be utilized, the user can select recipe and foodstuff without restriction on a provider. At the process of step S609, if a plurality of cooking recipes have been selected already, the entire list of the kinds and amounts of the foodstuffs required for the recipes after summing up the kinds and amounts of the all foodstuffs may be presented on the user terminal 503. In the process of step S611, after confirming the required foodstuffs the process may return the display of the other recipe selection for adding the other cooking recipe. In the processes of steps S611, S613, S615 and S617, by re-searching or additively searching the process may return to step S605, instead of step S607, for starting with the selection of the recipe site.

According to the system of this embodiment, since the user can directly order the required foodstuffs while browsing the cooking recipe, the period required for an online shopping is shortened, the connection charge for the network provider can be reduced, and therefore oversight of foodstuff order and extra order can be reduced.

A businessman who manages the coordination terminal reduces the choices or selective items for ordering or changes the presented contents at every user in accordance with accumulated personal data, and therefore the personalized business can be achieved.

Furthermore, since the system according to this embodiment comprises the delivery service provider terminal and the account settling agent terminal both connected with the coordination terminal, even the foodstuff provider without the delivery service system or the settlement agent service system can also join the system. When the foodstuffs are ordered by way of coordination terminal, the personal data such as the deliver destination are not transmitted to the foodstuff provider and the personal data specifying the user purchased the foodstuffs can keep in secret. On the other hand, the contents of delivery are not transmitted to the delivery service provider and the personal data specifying the purchased goods can keep in secret.

(Fourth Embodiment)

As a fourth embodiment of the present invention, the coordination service system wherein a user operates to order predetermined foodstuffs after browsing a cooking recipe by way of a coordination terminal on a network, therefore the foodstuffs required for cooking are informed to and are provided by a foodstuff provider, and the user accepts the foodstuff from the foodstuff provider is provided.

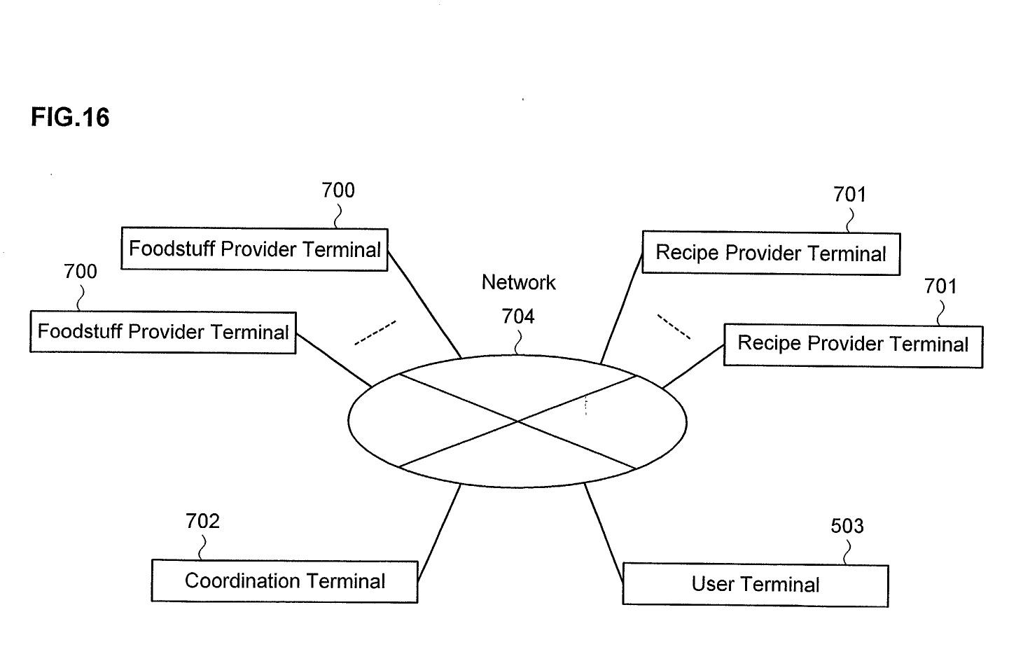

Referring now FIG. 16, the coordination service system according to the fourth embodiment of the present invention will be described hereinafter. FIG. 16 is a block diagram showing a construction of the coordination service system according to the fourth embodiment. The construction of the coordination service system shown in FIG. 16 is similar to the first embodiment of the present invention, however the foodstuff provider terminal has only a function of accepting an order of a foodstuff.

The reference numeral 700 denotes a foodstuff provider terminal for presenting a list of foodstuffs and for accepting an order of foodstuffs. The reference numeral 701 denotes a recipe provider terminal for providing a cooking recipe. The reference numeral 702 denotes a coordination terminal for performing coordination. The reference numeral 703 denotes a user terminal and the reference numeral 704 denotes a network.

In the system of this embodiment, the foodstuff provider terminal 700 comprises a database storing names, prices, amounts and the like of foodstuffs, which can be provided. The foodstuff provider terminal 700 further comprises order-accepting system including a system that is capable of accepting an order by way of a network.

The recipe provider terminal 701 comprises a database storing names, ingredients, preparations and the like, and a system capable of browsing the cooking recipes by way of the network by a user.

The coordination terminal 702 has a function for storing personal data of users, information of foodstuff providers, information of recipe providers and information of delivery service providers in a database, and a function for providing an user terminal 703 with a system capable of directly ordering ingredients, i.e., foodstuffs, by a cooking recipe.

The user terminal 703 connected to the network comprises a means for displaying information from the recipe provider terminal 701, information from the foodstuff provider terminal 700 or information from coordination terminal 702, and for inputting information in case of necessity. The network 704 connected with the terminals 700, 701, 702 and 703.

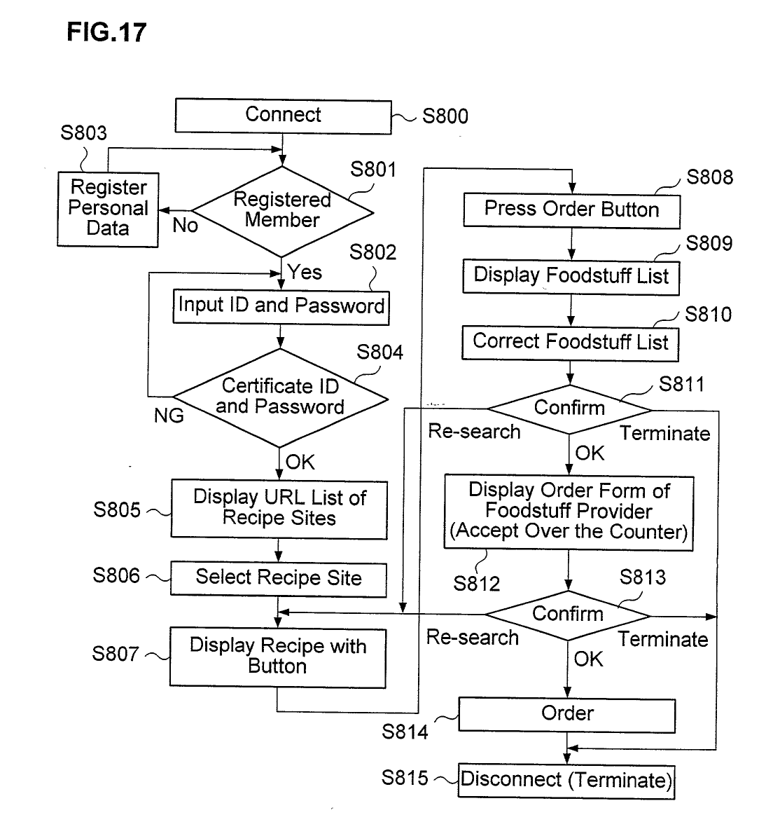

Referring now FIG. 17, a flow of an operation of the user terminal for the coordination service system according to the fourth embodiment of the present invention will be described hereinafter. FIG. 17 is a flowchart showing a operation process flow of a user terminal in a coordination service system according to the fourth embodiment.

In this embodiment, when a user intends to utilize the coordination service system, the user registers previously the personal data onto the coordination terminal 702. The user registers information that specifies an individual, and information such as a over the counter receipt of a foodstuff without a delivery service and exchanging a foodstuff with a payment instead of an electronic settlement. A method for registering the personal data does not restrict especially. Security of messages sent and received among terminals 700, 701, 702 and 703 by way of network 704 are protected entirely and an environment capable of sending and receiving messages safely is provided.

At first, in step S800, the user connects to the coordination terminal 702 by using the user terminal 703 (step S800). This corresponds to that the user designates the URL of the coordination terminal 702 by using a general-purpose Web browser.

Next, in step S801, the system determines whether the user is a registered member or not (step S801). In case of the user is determined as a registered member, the process advances to step S801 where a user name, password and the like is inputted (step S802), and, thereafter in step S804, the system determines whether the user name, password and the like inputted is correct or not (step S804).

In case of the system determines that user is not a registered member, the process switches to step S803, where a registration page is displayed for urging a registration (step S803).

In step S804, the system determines the user name, password and the like inputted is correct, the process advances to step S805 where a page provided by the coordination terminal 302 is displayed (step S805). On this situation, the coordination terminal 702 presents a URL list of a plurality of terminals that provides cooking recipes on the user terminal as shown in FIG. 3. This means that a URL of a site providing a cooking recipe is displayed within a page provided by the coordination terminal 702 as a URL link. This URL is displayed after associated previously with the cooking recipe provider.

Next, in step S806, user selects the desired one site from the presented URL list of the plurality of terminals providing cooking recipes (step S806). Then, the process advances to step S807 where the user browses a recipe page provided by the selected terminal. On this situation, such as a foodstuff ordering button is displayed additively to a screen image presented by the recipe provider site within the same display screen on the user terminal 703 as shown in FIG. 4.

The user searches the required cooking recipe in the recipe provider site with a variety of searching methods. In step S808, if the user reached to the page for the required cooking recipe, then the user presses the foodstuff ordering button (step S808). By this operation, in step S809, the coordination terminal 702 presents a list of kinds and amounts of foodstuffs required for cooking the selected recipe on the user terminal 703 as shown in FIG. 5 (step S809).

As the method for obtaining the kinds and amounts of the foodstuffs required for cooking, extracting the corresponding part from the displayed cooking recipe or requesting the list of the ingredients of the selected cooking recipe to the recipe provider can be utilized.

Further, in step S810, user corrects the presented contents such as leaving only the required foodstuffs by deleting the unnecessary foodstuffs, or changing amounts of the foodstuffs (step S810). Thereafter, the process advances to step S811 where user presses a confirming button (step S811). Alternatively, canceling this operation and returning to the display for selection of the recipes can be selected.

Then the coordination terminal 702 selects the foodstuff provider terminal 700 which can provide the required foodstuffs and hand over to the user over the counter. If all the required foodstuffs could not be provided on a single foodstuff provider, a plurality of foodstuff provider terminals 700 could be selected. For selecting the foodstuff provider, the method that the coordination terminal 702 sends the information of the foodstuffs to the foodstuff providers and selects the foodstuff provider that replied a capability of providing all or a part of the foodstuff can be employed. In case of there are a plurality of possibilities of the foodstuff provider, the method of selecting by user or the method for selecting according to the priority (such as the providers with low prices, providers with high qualities, providers in a short distance or the like) predetermined by user can also be employed.

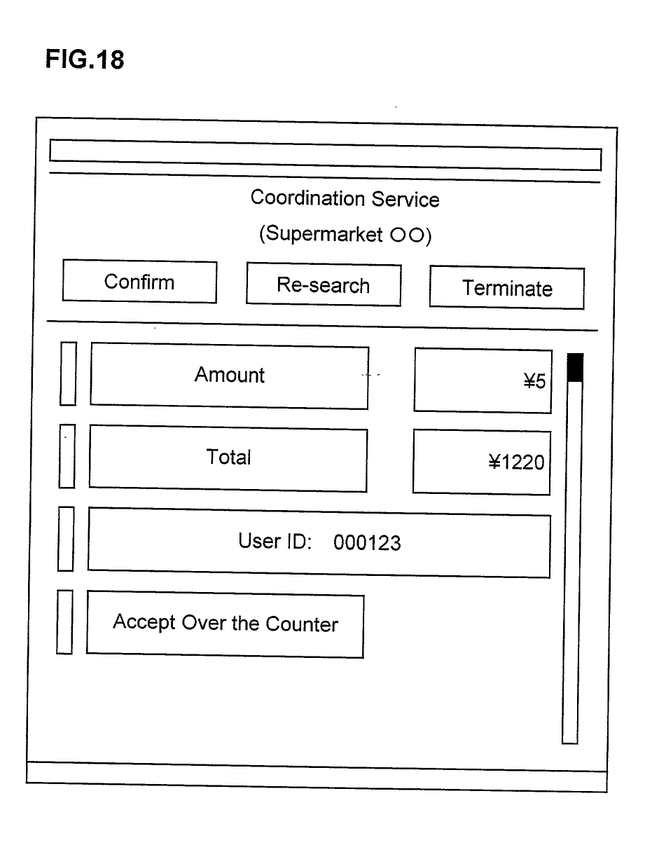

Thus, when the foodstuff provider is determined, the process advances to step S812 where the coordination terminal 702 obtains an order form from the selected foodstuff provider as shown in FIG. 6(a), the user fills the corresponding portions of the form with at least a part of the kinds of the foodstuffs ordered, amounts and so forth, and presented on the user terminal 703 as shown in FIG. 18 (step S812). Where instead of the information for the settlement such as a number of the credit card or the bank account of the user, an item for accept over the counter is displayed, and the amounts of the foodstuffs are displayed in unit of handling by the foodstuff provider enough for required amounts.

Next, the process advances to step S813 where the user confirms the contents of the order form and makes the required correction if any, and then user presses the confirmation button (step S813). Alternatively, canceling this operation and returning to the display for selection of the recipes, for example, can also be selected.

Furthermore, when the user press the confirmation button, the process advances to step S814 where the contents of the order form of the foodstuffs are sent to the foodstuff provider terminal 700 (step S814), and on step S815, the process for ordering is terminated (step S815). The foodstuff provider receives the order of the foodstuffs at the foodstuff provider terminal 700, provides the foodstuffs corresponding to the contents of the order and hands over the foodstuffs to the visited user in exchange for the payment.

As described above, since the coordination terminal according to this embodiment utilizes a database and a searching function of the recipe provider terminal, and a database, a searching function and an ordering function of the foodstuff provider terminal, the coordination terminal does not need to have a database of contents of cooking recipe and foodstuff, and a searching function, therefore easily constructs a coordination service system. Since the information of recipe sites and the information for providing foodstuff itself on a network can be utilized, the user can select recipe and foodstuff without restriction on a provider. At the process of step S809, if a plurality of cooking recipes have been selected already, the entire list of the kinds and amounts of the foodstuffs required for the recipes after summing up the kinds and amounts of the all foodstuffs may be presented on the user terminal 703. In the process of step S811, after confirming the required foodstuffs the process may return the display of the other recipe selection for adding the other cooking recipe. In the processes of steps S811 and S813, by re-searching or additively searching the process may return to step S805, instead of step S807, for starting with the selection of the recipe site.

According to the system of this embodiment, since the user can directly order the required foodstuffs while browsing the cooking recipe, the period required for an online shopping is shortened, the connection charge for the network provider can be reduced, and therefore oversight of foodstuff order and extra order can be reduced.

A businessman who manages the coordination terminal reduces the choices or selective items for ordering or changes the presented contents at every user in accordance with accumulated personal data, and therefore the personalized business can be achieved.

According to the system of this embodiment, since the foodstuffs have been provided and the payment of them have been calculated previously, the time required for purchasing the foodstuffs at the shop is remarkably shortened. The system can be utilized even if the user does not use the credit card or electronic settlement.

Hereinbefore, the preferred embodiments according to the present invention are described, however the present invention limited in such the constructions. It will be understood by those skilled in the art that various changes and modifications may be made therein without departing from the spirit and scope of the present invention, and those changes and modification is incorporated in the spirit and scope of the present invention.

For example, in the above embodiments the system which coordinates the combination of providing of cooking recipes and providing of foodstuffs is described, however the subjects for coordination are not limited such an example. The combination of two or more subjects for providing, which includes the predetermined job method and the job components such as materials or tools, e.g., the combination of providing of designs for a Sunday carpenter and providing of the materials, such as woods, the combination of providing of methods for cleaning and providing of cleaning equipments, and the like, can be embodied.

In this system, the coordination terminal is not required for storing database of cooking recipes or database of foodstuffs and for containing function of searching and retrieving cooking recipes or foodstuffs. According to that system, as there is no necessity that a user browses foodstuff provider sites after browsing cooking recipe sites scattered on a network, the user can operate to order in a short time using an intuitive interface. A user can accept a service without limitation on selecting a job (cooking dish), because all of job method provider sites (cooking recipe provider sites) and job component provider sites (foodstuff provider sites) on a network can be utilize.

The entire disclosure of Japanese Patent Application No. 2000-97855 filed on Mar. 30, 2000 including specification, claims, drawings and summary is incorporated herein by reference in its entirety.

What is claimed is:

1. A coordination service system which includes a service system comprising a plurality of job method provider terminals for providing information Web pages for a predetermined job method, and a plurality of job component provider terminals for providing job components necessary to perform said predetermined job method, for delivering said job components and for settling an account of a payment for said job components, said job method provider terminals and said job component provider terminals both being connected to a user terminal via a computer network, characterized by further comprising:
a coordination terminal for ordering said job components necessary for said predetermined job method, on said information Web pages of said predetermined job method, browsed by said user, directly from said job component provider terminal.

2. A coordination service system as claimed in claim 1 characterized in that said coordination terminal includes a means for ordering from the job component provider having delivery service system so as to deliver said job components.

3. A coordination service system as claimed in claim 2 characterized in that said coordination terminal includes a means for ordering from the job component provider so as to settle electronically an account of a payment for said job components.

4. A coordination service system as claimed in claim 2 characterized in that said coordination terminal includes a means for ordering from the job component provider so as to collect a payment for said job components when delivering it to the user.

5. A coordination service system as claimed in claim 1 characterized in that said coordination terminal includes a means for ordering from the job component provider so as to collect a payment for said job components on handing it to the user at a shop of said job component provider.

6. A coordination service system which includes a service system comprising a plurality of job method provider terminals for providing information Web pages for a predetermined job method, a plurality of job component provider terminals for providing job components necessary to perform said predetermined job method and for settling an account of a payment for said job components, and delivery service terminal for delivering said job components, said job method provider terminals, said job component provider terminals and said delivery service terminal being connected to a user terminal via a computer network, characterized by further comprising:
a coordination terminal for ordering said job components, on said information Web pages of said predetermined job method, browsed by said user, directly from said job component provider terminal, and for ordering to collect and deliver said job components from said delivery service terminal.

7. A coordination service system as claimed in claim 6 characterized in that said coordination terminal includes a means for presenting required said job components extracted from said information Web pages for said predetermined job method browsed by said user, on said user terminal.

8. A coordination service system as claimed in claim 6 characterized in that said coordination terminal includes:
a means for requesting a plurality of said job method provider terminal to send a list of said job components required for said predetermined job method; and
a means for presenting said list of said job components, which are sent, on said user terminal.

9. A coordination service system as claimed in claim 7 characterized in that said coordination terminal includes a means for selecting at least one job component required for said user from said job components presented.

10. A coordination service system as claimed in claim 8 characterized in that said coordination terminal includes a means for selecting at least one job component required for said user from said job components presented.

11. A coordination service system as claimed in claim 9 characterized in that said coordination terminal includes:
a means for sending a first information of said job components, which are required, to said plurality of job component provider terminal; and
a means for presenting a second information of said job component providers, which respond to said first information sent with being available to provide all of or a part of said job components, and said job components on said user terminal.

12. A coordination service system as claimed in claim 10 characterized in that said coordination terminal includes:
a means for sending a first information of said job components, which are required, to said plurality of job component provider terminal; and
a means for presenting a second information of said job component providers, which respond to said first information sent with being available to provide all of or a part of said job components, and said job components on said user terminal.

13. A coordination service system as claimed in claim 11 characterized in that said coordination terminal includes a means for selecting at least one job component provider which is to be ordered by said user from among said job component providers.

14. A coordination service system as claimed in claim 12 characterized in that said coordination terminal includes a means for selecting at least one job component provider which is to be ordered by said user from among said job component providers.

15. A coordination service system as claimed in claim 13 characterized in that said coordination terminal includes a means for selecting at least one job component provider which is to be ordered by said user based on a priority predefined by said user from among said job component providers.

16. A coordination service system as claimed in claim 14 characterized in that said coordination terminal includes a means for selecting at least one job component provider which is to be ordered by said user based on a priority predefined by said user from among said job component providers.

17. A coordination service system as claimed in claim 13 characterized in that a plurality of job component provider is selected by said selecting means.

18. A coordination service system as claimed in claim 14 characterized in that a plurality of job component provider is selected by said selecting means.

19. A coordination service system as claimed in claim 17 characterized in that said coordination terminal includes a means for presenting an amount of said job component ordered in unit that handled by said job component provider.

20. A coordination service system as claimed in claim 18 characterized in that said coordination terminal includes a means for presenting an amount of said job component ordered in unit that handled by said job component provider.

21. A coordination service system which includes a service system comprising a plurality of job method provider terminals for providing information Web pages for a predetermined job method, a plurality of job component provider terminals for providing job components necessary to perform said predetermined job method, delivery service terminal for delivering said job components and an accounting agent terminal for settling an account of a payment for said job components, said job method provider terminals, said job component provider terminals, said delivery service terminal and said accounting agent terminal being connected to a user terminal via a computer network, characterized by further comprising:
a coordination terminal for ordering said job components, on said information Web pages of said predetermined job method, browsed by said user, directly from said job component provider terminal, for ordering to collect and deliver said job components from said delivery service terminal and for requesting to said accounting agent terminal for settling an account of a payment for said job components.

22. A coordination service system as claimed in claim 21 characterized in that said coordination terminal includes a privacy leakage preventing means for preventing from leaking out personal data other than data necessary for the job component provider and the delivery service, the order from said job component provider terminal and said delivery service terminal performing by way of said privacy leakage preventing means.

23. A coordination service system as claimed in claim 21 characterized in that said coordination terminal includes a means for presenting required said job components extracted from said information Web pages for said predetermined job method browsed by said user, on said user terminal.

24. A coordination service system as claimed in claim 21 characterized in that said coordination terminal includes:
a means for requesting a plurality of said job method provider terminal to send a list of said job components required for said predetermined job method; and
a means for presenting said list of said job components, which are sent, on said user terminal.

25. A coordination service system as claimed in claim 23 characterized in that said coordination terminal includes a means for selecting at least one job component required for said user from said job components presented.

26. A coordination service system as claimed in claim 24 characterized in that said coordination terminal includes a means for selecting at least one job component required for said user from said job components presented.

27. A coordination service system as claimed in claim 25 characterized in that said coordination terminal includes:
a means for sending a first information of said job components, which are required, to said plurality of job component provider terminal; and
a means for presenting a second information of said job component providers, which respond to said first information sent with being available to provide all of or a part of said job components, and said job components on said user terminal.

28. A coordination service system as claimed in claim 26 characterized in that said coordination terminal includes:
a means for sending a first information of said job components, which are required, to said plurality of job component provider terminal; and
a means for presenting a second information of said job component providers, which respond to said first information sent with being available to provide all of or a part of said job components, and said job components on said user terminal.

29. A coordination service system as claimed in claim 27 characterized in that said coordination terminal includes a means for selecting at least one job component provider which is to be ordered by said user from among said job component providers.

30. A coordination service system as claimed in claim 28 characterized in that said coordination terminal includes a means for selecting at least one job component provider which is to be ordered by said user from among said job component providers.

31. A coordination service system as claimed in claim 29 characterized in that said coordination terminal includes a means for selecting at least one job component provider which is to be ordered by said user based on a priority predefined by said user from among said job component providers.

32. A coordination service system as claimed in claim 30 characterized in that said coordination terminal includes a means for selecting at least one job component provider which is to be ordered by said user based on a priority predefined by said user from among said job component providers.

33. A coordination service system as claimed in claim 29 characterized in that a plurality of job component provider is selected by said selecting means.

34. A coordination service system as claimed in claim 30 characterized in that a plurality of job component provider is selected by said selecting means.

35. A coordination service system as claimed in claim 33 characterized in that said coordination terminal includes a means for presenting an amount of said job component ordered in unit that handled by said job component provider.

36. A coordination service system as claimed in claim 34 characterized in that said coordination terminal includes a means for presenting an amount of said job component ordered in unit that handled by said job component provider.
